(19) United States
(12) Patent Application Publication
(10) Pub. No.: US 2011/0264464 A1
(43) Pub. Date: Oct. 27, 2011

(54) DATA MANAGEMENT AND ACCESS FOR DRUG AND PROCEDURAL TESTING

(76) Inventors: James Fonger, Atlanta, GA (US); Nicolas Chronos, Atlanta, GA (US)

(21) Appl. No.: 13/030,724

(22) Filed: Feb. 18, 2011

Related U.S. Application Data
(60) Provisional application No. 61/306,230, filed on Feb. 19, 2010.

(51) Int. Cl. G06Q 50/00; G06Q 10/00

(52) U.S. Cl. 705/3

(57) ABSTRACT

Methods, systems, and apparatus, for data management and access for drug and procedural testing. In one aspect, a method includes receiving dynamic trial data for an ongoing trial from a trial site, associating the dynamic trial data with a corresponding ongoing trial, storing the dynamic trial data for the ongoing trial in a data store, receiving a request to access the trial data for an ongoing trial and receiving sponsor credentials associated with the request, the sponsor credentials identifying a sponsor that provided the request, determining that the sponsor identified by the request is the sponsor of the ongoing trial for which the access to the trial data is requested, and in response to the determination, providing access to the trial data in response to the request, the access to the trial data including access to the dynamic trial data for the ongoing trial.

### CROSS-REFERENCE TO RELATED APPLICATIONS

This application claims the benefit of U.S. Provisional Application Ser. No. 61/306,230, filed Feb. 19, 2010. The entire disclosure of the prior application is hereby incorporated by reference.

### BACKGROUND

This specification generally relates to drug testing and medical procedure testing.

Medical professionals are constantly developing new medicines, treatments and procedures. Two stages that occur in the development process are preclinical trials and clinical trials. Preclinical trials are laboratory tests of a new drug, treatments and/or procedures on animal subjects, and are conducted to determine whether to move forward with clinical trials. Clinical trials are research studies in human beings that follow the preclinical trials. Both trials are done according to protocols, which define what types of subjects can participate in the trial, the schedule of tests, procedures, medications, dosages, and the length of the trial.

Drug manufactures and device manufactures sponsor trials for the new medicines, treatments and procedures they are developing. During the preclinical study state, the sponsors will typically contract with a vivarium, a facility that carries out trials on animals according to protocols the sponsor defines. The preclinical trials are an expensive process, and the sponsors may desire to monitor the status of the ongoing trials and review trial data in order to assess the current state of ongoing trials.

Typically, a sponsor will monitor an ongoing trial by either having a representative at the trial site where the ongoing trial is being conducted, or by periodically receiving reports, records, and other data from the trial site. Often, however, the place of employment of the sponsors and the trial site are at different locations, sometimes in different cities or in different states. Accordingly, the sponsor must incur travel costs and possibly lodging costs if the sponsor wants to monitor a trial while it is ongoing.

If the sponsor decides to monitor an ongoing trial by reviewing data that is sent to the sponsor from the trial site, then the sponsor often needs to contend with the time between the collection of the trial data and the delivery of the trial data to the sponsor. Even with electronic delivery, e.g., e-mail or file transfer protocol delivery, the sponsor still must wait for the investigators at the trial site to prepare the trial data for delivery to the sponsor. This can result in hours or even days of delay from the time that the trial data are collected to the time that the sponsor actually reviews the trial data.

### SUMMARY

This specification describes technologies relating to drug testing and medical procedure testing.

In general, one innovative aspect of the subject matter described in this specification can be embodied in a system that includes a data store and a data processing apparatus, the data store storing trial data for ongoing trials, each ongoing trial sponsored by a respective sponsor and being conducted according to a respective protocol specifying subjects participating in the ongoing trial and a schedule of procedures and tests for the ongoing trial, and wherein the trial data include dynamic trial data for each ongoing trial, the dynamic trial data for each ongoing trial being data describing current states of subjects participating in the ongoing trial and data collected in response to actions taken according to the schedule of procedures and tests specified by the protocol for the ongoing trial; the data processing apparatus in data communication with the data store, the data processing apparatus including a memory storing instructions executable by the data processing apparatus and that upon such execution cause the data processing apparatus to perform operations comprising: receive, over a network, dynamic trial data for an ongoing trial from a trial site; associate the dynamic trial data with a corresponding ongoing trial; store the dynamic trial data for the ongoing trial in the data store; receive, over the network, a request to access the trial data for an ongoing trial; receive, from a client device, sponsor credentials associated with the request, the sponsor credentials identify a sponsor that provided the request; identifying trial data associated with the sponsor that provided the request; and provide access to the trial data identified in response to the request, the access to the trial data including access to the dynamic trial data for the ongoing trial. Other embodiments of this aspect include corresponding systems, apparatus, and computer programs, configured to perform the actions of the methods, encoded on computer storage devices.

Particular embodiments of the subject matter described in this specification can be implemented to realize one or more of the following advantages. Sponsors can monitor ongoing trials in real time or near real time without being required to be on location at a trial site, thereby reducing the cost of travel and lodging that would otherwise be required for on-site monitoring. Additionally, access to trial data for trials is made available as the trial data are entered into the system while the trial is ongoing, thus giving the sponsor a timely and up-to-date snapshot view of all ongoing trials that sponsor is sponsoring. Additionally, the trial data are tagged (associated with) a particular sponsor so that trial data are automatically aggregated with other trial data for that sponsor, thereby simplifying the process of providing trial data to particular sponsors. Sponsors can also provide feedback, ask questions, and adjust treatments in real-time by use of videoconference links, thereby reducing the need to repeat procedures and treatments that would otherwise be required in the absence of a videoconference link, resulting in cost savings. The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1A is block diagram of a trial data management and access system that provides data access and management for trials.

FIG. 1B is a block diagram of an environment in which the system of FIG. 1A is deployed.

FIG. 2 is an image of a landing page for a trial data access and management system.

FIG. 3 is an image of a projects page for the trial data access and management system.

FIG. 4 is an image of a projects overview page for the trial data access and management system.

FIG. 5 is an image of a projects schedule page for the trial data access and management system.

FIG. 6 is an image of a projects schedule calendar page for the trial data access and management system.

FIG. 7 is an image of a communications option page for the trial data access and management system.

FIG. 8 is an image of a video conference selection page for the trial data access and management system.

FIG. 9 is an image of a live procedure video feed selection page for the trial data access and management system.

FIG. 10 is an image of a frame of a live procedure video feed.

FIG. 11 is an image of a study documents page for the trial data access and management system.

FIG. 12 is an image of a study setup page for the trial data access and management system.

FIG. 13 is an image of a publications page for the trial data access and management system.

FIG. 14 is an image of a budgets and protocols page for the trial data access and management system.

FIG. 15 is an image of a study reports page for the trial data access and management system.

FIG. 16 is an image of an echocardiogram page for the trial data access and management system.

FIG. 17 is an image of an echocardiogram files page for the trial data access and management system.

FIG. 18 is an image of a frame of an echocardiogram video.

FIG. 19 is an image of a video archives page for the trial data access and management system.

FIG. 20 is an image of a fluoroscopy page for the trial data access and management system.

FIG. 21 is an image of an endoscopy page for the trial data access and management system.

FIG. 22 is an image of a vascular physiology page for the trial data access and management system.

FIG. 23 is a vascular physiology report image displayed in the vascular physiology page.

FIG. 24 is a histological report image displayed in a histology page.

FIG. 25 is a flow chart of an example process for managing dynamic data for a trial.

FIG. 26 is a block diagram of a programmable processing system.

Like reference numbers and designations in the various drawings indicate like elements.

### DETAILED DESCRIPTION

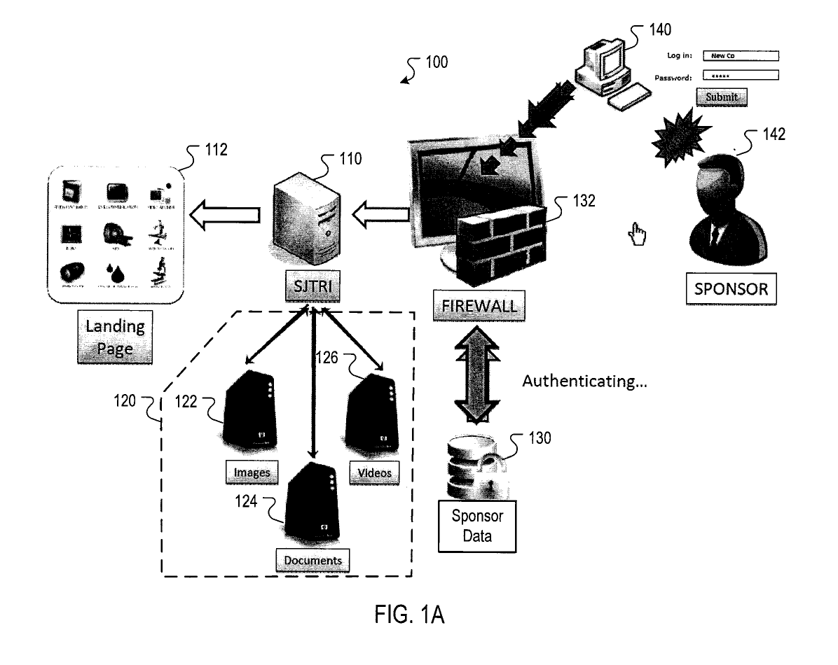

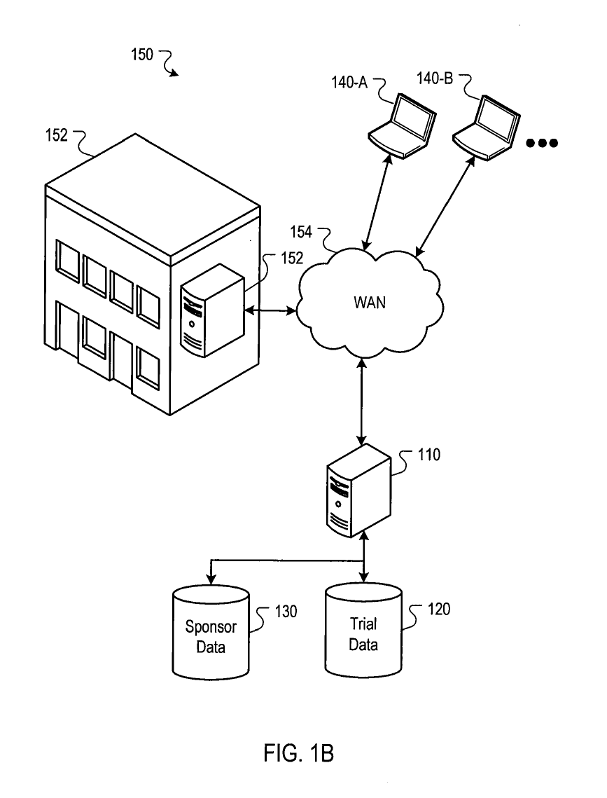

FIG. 1A is block diagram of a trial data access and management system 100 that provides data access and management for trials, and FIG. 1B is a block diagram of an environment 150 in which the system 100 of FIG. 1A is deployed. The system 100 includes a data processing apparatus 110 in data communication with the trial data store 120. The data processing apparatus 110 includes a memory storing instructions executable by the data processing apparatus and that upon such execution cause the data processing apparatus 110 to perform operations described below. In some implementations, the data processing apparatus 110 is implemented in one of more server computers.

The trial data store 120 stores trial data for ongoing trials. Example trial data includes images 122, documents 124, and videos 126. Each ongoing trial is sponsored by a respective sponsor 142 and is conducted according to a respective protocol specifying subjects participating in the ongoing trial and a schedule of procedure and tests for the ongoing trial.

As the trials are ongoing, the trial data are dynamic, i.e., the data are in the process of being updated as data and results are collected for the ongoing trial. The trial data describe current states of subjects participating in the ongoing trials, data collected in response to actions taken according to the schedule of procedures, and tests specified by protocols for the ongoing trials.

Example trials include preclinical studies and clinical studies. For the remainder of this description, the system 100 is described in the context of preclinical studies. Data for other types of trials can also be managed and accessed by the system 100 of FIG. 1A, however.

As used herein, the term “sponsor” refers to an entity, such as a person, a business, or a governmental entity that has commissioned a particular trial. For example, the sponsor 142 may be a drug company conducting a preclinical study for a new drug. The sponsor 142, by use of a client device 140, can access the data processing apparatus 110 to monitor the data collected for its ongoing trials. In some implementations, data associating sponsors with trials and sponsor credentials are stored in the sponsor data store 130. To access the trial data for its respective ongoing trial, the sponsor 142 provides sponsor credentials associated with an access request. The sponsor credentials identify the sponsor 142 that provided the request. Example sponsor credentials are a login name and password.

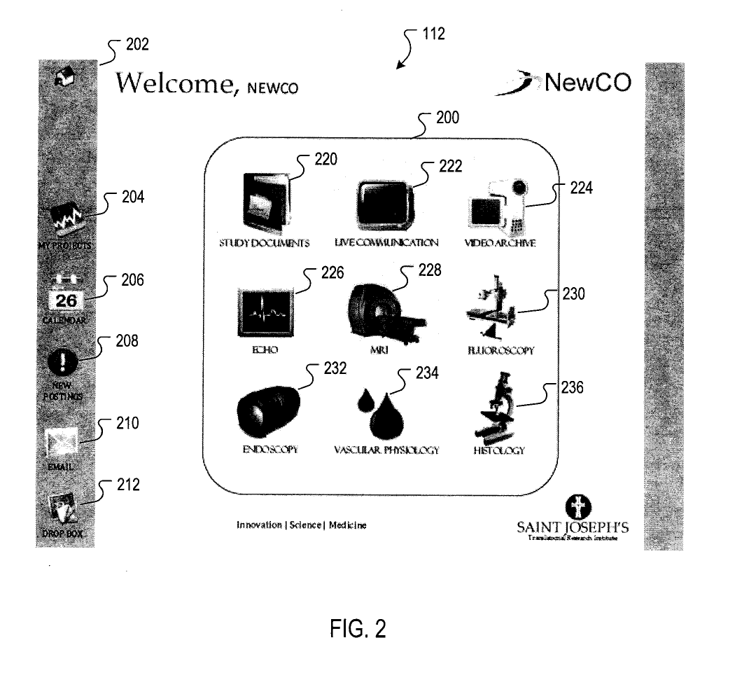

A security layer, which includes a firewall 132 and login authentication, is used to validate the sponsor login. Once the login is validated, the data processing apparatus 110 identifies trial data associated with the sponsor 142, and provides a landing page 112 to the client device 140. Through the landing page 112, the sponsor 142 can access the identified trial data so that sponsor 142 can review the trial data, including the dynamic trial data, of the trial(s) that the sponsor 142 is sponsoring. Example review and data management functions provided by the data processing apparatus 110 are described with reference to FIGS. 2-24 below.

During the ongoing trial, the data processing apparatus 110 receives, over a network, dynamic trial data for an ongoing trial from a trial site. For example, as shown in FIG. 1B, data processing apparatus 110 can receive dynamic trial data from a vivarium 152 over a network 154. The vivarium 152 can include multiple computer devices that are in data communication with the data processing apparatus 110, and that can receive dynamic trial data input by one or more investigators carrying out an ongoing trial according to the respective protocol for the ongoing trial. Example computer devices include client desktop computers, mobile computers, video processing devices capable of providing real-time video and audio links, laboratory and test equipment with data communication capabilities, and other computer devices capable of receiving trial data as input, and communicating the input trial data to the data processing apparatus 110.

In some implementations, the data input to the computer devices for an ongoing trial are tagged (associated with) a sponsor that is sponsoring the trial. For example, an investigator may be required to enter a sponsor identifier when entering trial data into a computer device. Alternative, the data can be automatically tagged according to a schedule. For example, a laboratory may be scheduled for a particular procedure to occur during a certain time and date. When the procedure commences, a video feed from the laboratory may be automatically associated with the sponsor and particular trial that the sponsor is sponsoring. The automatic tagging can, in some implementations, be subject to manual review before the tagging occurs so that the trial data are not incorrectly associated due to last minute scheduling changes or other events that may cause an association error.

When the data processing apparatus 110 receives trial data from the test site 152, the data processing apparatus 110 associates the trial data with a corresponding ongoing trial. For example, as described above, an investigator will access the data input environment associated with a particular ongoing trial for sponsor 142 when inputting the trial data for the respective sponsor, or the data may have been automatically tagged for association. Once the trial data is associated with an ongoing trial, the data processing apparatus stores the trial data and the association in the trial data store 120.

Although only one test site 152 is shown, the data processing apparatus 110 can receive and manage trial data from multiple test sites 152. For example, the data processing apparatus 110 and the services and capabilities provided by the data processing apparatus 110 can be managed by a third party data separate from the sponsors and the test site(s) 152. The test sites 152 can then provide these additional services to sponsors.

Alternatively, the data processing apparatus 110 can be located within the test site 152 and managed by the test site 152. For example, a particular test site 152 can maintain and manage the data processing apparatus at the test site 152. Other configurations are also possible.

The data processing apparatus 110 can manage a variety of trial data. In some implementations, the trial data include trial records, with each record detailing biological parameters and procedures related to one or more subjects participating in the ongoing trial. The trial data can also include reports, documents, images and video resources.

The images can graphically depict procedure results in assessments, and other data, related to an ongoing trial. The video resources can include live video streams and stored video files. For example, the data processing apparatus 110 can receive a video stream of an ongoing procedure being performed on a subject participating in an ongoing trial at the trial site 152, and the sponsor 142 can view the video stream at the client device 140 in real time. In some implementations, the video stream can be accompanied by two-way audio link so that the sponsor 142 can discuss the procedure, ask questions, and even provide direction to the investigator performing the procedure while the procedure is ongoing. The data processing apparatus 110 can store the video received over the video stream, and the audio accompanying the video, in an archived video file that can be later accessed by the sponsor 142.

FIG. 2 is an image of the landing page 112 for the trial data access and management system. The landing page 112 is displayed on the client device 140 in response to validation of the sponsor's credentials. The landing page 112 provides access to trial data of ongoing trials that are being sponsored by the sponsor 142. The landing page 112 includes trial data selection environment 200 and menu bar 202, and provides access to trial data for ongoing trials for particular sponsor. The example layout in the landing page 112 is illustrative only, and other configurations can also be used, such as a hierarchical menu with context dependent menu selections, for example.

The menu bar 202 includes a projects icon 204, calendar icon 206, a new postings icon 208, an e-mail icon 210, and a drop box icon 212. Selection of the projects icon 204 generates a projects list environment that lists ongoing trials sponsored by the sponsor 142. Selection of the calendar icon 206 generates a calendar environment that includes procedures, tests, and other events related to trials sponsored by the sponsor 142. Selection of the new postings icon 208 generates a postings environment in which the sponsor 142 can review postings from the investigators, and can also provide postings for review by the investigators. Selection of the e-mail icon 210 generates an e-mail environment in which the sponsor 142 can send and receive e-mails to investigators that are conducting the ongoing trial. Selection of a drop box icon 212 generates a drop box environment in which the sponsor 142 can provide documents, videos, and other data for access by the investigators, and in which the sponsor 142 can access documents, videos, and other data that have been provided by the investigators for access by the sponsor.

The trial data selection environment 200 includes icons representative of different types of trial data that are available to the sponsor 142. In the example landing page 112, example icons include a study document icon 220, a live communication icon 222, a video archive icon 224, an echocardiogram icon 226, a magnetic resonance imaging icon 228, a fluoroscopy icon 230, an endoscopy icon 232, a vascular physiology icon 234 and a histology icon 236. More or fewer icons can also be shown, depending on the data being collected for the ongoing trials that the sponsor 142 is sponsoring.

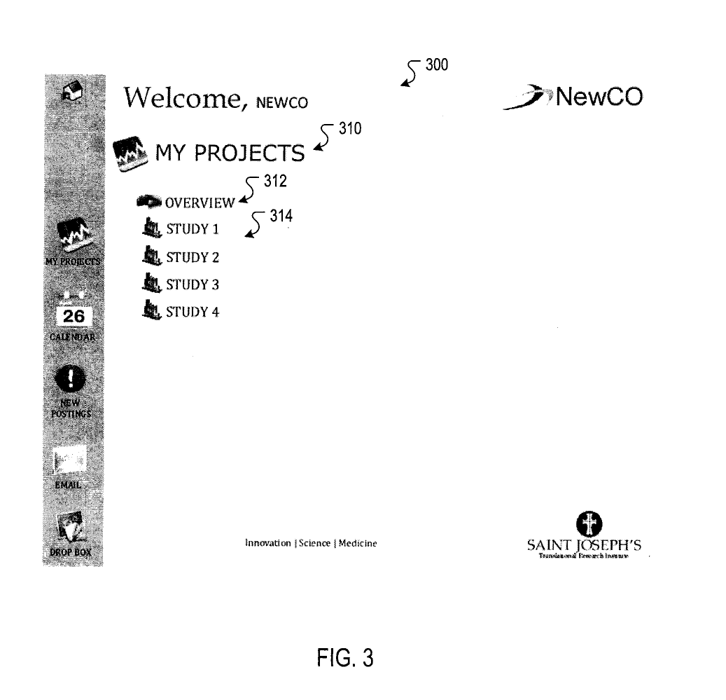

FIG. 3 is an image of a projects page 300 for the trial data access and management system 100. The projects page 300 is provided in response to a selection of the projects icon 204.

The projects page 300 includes a projects header 310 beneath which is an overview link 312 and study links 314. Selection of the overview link 312 provides a summary overview of all studies (i.e., ongoing trials) that are currently ongoing for the sponsor 142. Selection of an individual study link 314 provides detailed data pertaining to the particular study that corresponds to the selected study link.

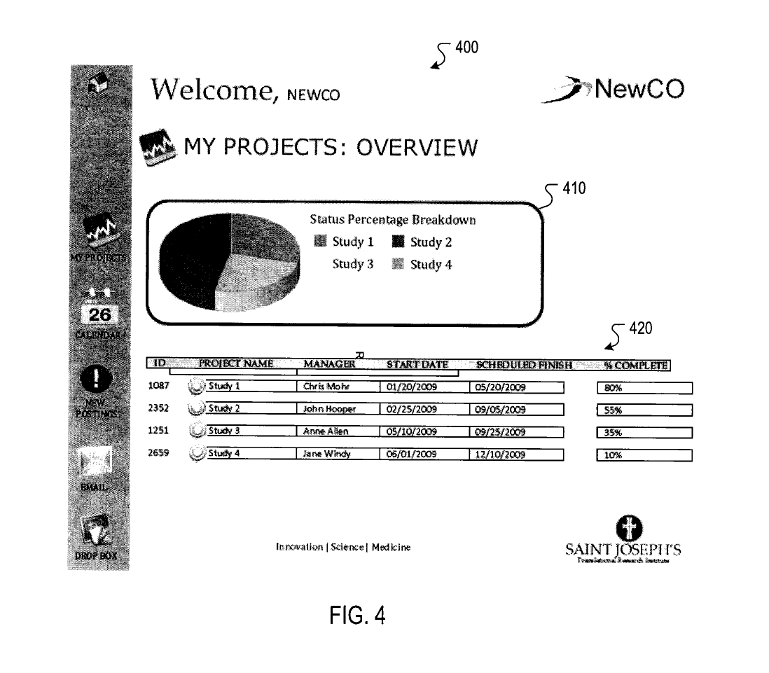

FIG. 4 is an image of a projects overview page 400 for the trial data access and management system 100. The projects overview page 400 is provided in response to the selection of the overview link 312 in the projects page 300.

The projects overview page 400 includes a pie chart overview 410 that graphically depicts the resource allocations for all ongoing trials sponsored by a sponsor 142. Additionally, the projects overview page 400 includes a table 420 detailing individual statistics for ongoing trials that are sponsored by the sponsor 142. For example, the table 420 includes columns specifying a trial identifier number, a project name, a manager, an actual start date of the trial, a schedule for the end of the trial, and a completion percentage of the trial. Additional statistics, or fewer statistics, can be shown in the table 420.

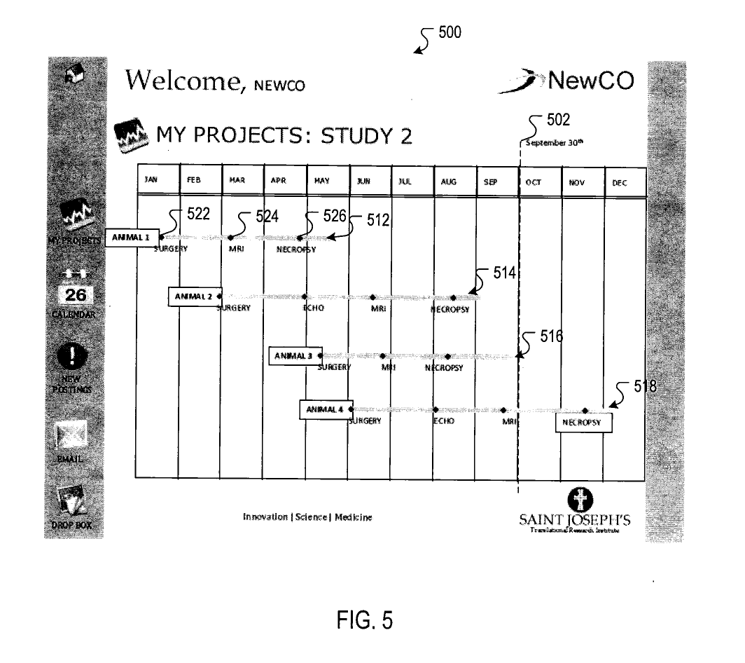

FIG. 5 is an image of a projects schedule page 500 for the trial data access and management system 110. The projects schedule page 500 is provided in response to a selection of a corresponding trial row in the table 420 of FIG. 4, and provides a progress overview of an ongoing trial.

The project schedule page 500 includes a monthly calendar 502 for a particular study. The calendar 502 includes dates related to procedures, tests, and other actions performed and to be performed for an ongoing trial. A date bar 502 indicates a current date. As illustrated in FIG. 5, progress entries 512, 514 and 516, related to actions for three participants participating in ongoing trials, indicate that procedures and test related to the three participants are complete. Procedures and test related to a fourth participant are ongoing, as indicated by the progress entry 518 intersecting the date bar 502.

In some implementations, the progress entries include access links through which trial data for particular procedures can be accessed by the sponsor 142. For example, selection of the access link 532 will provide the sponsor 142 with trial data related to a surgical procedure performed on a participating subject, such as archived video files, reports, evaluations, and other data. Likewise, selection of the access link 524 will provide the sponsor 142 with trial data related to the magnetic resonance imaging data for the participating subject, and so on.

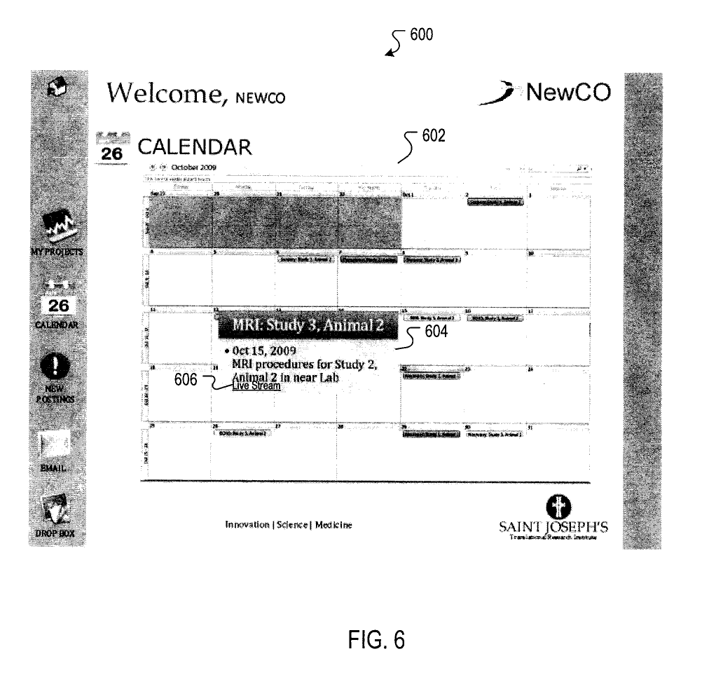

FIG. 6 is an image of a projects schedule calendar page 600 for the trial data access and management system 100. The calendar page 600 is provided in response to selection of the calendar icon 206 of FIG. 2, and provides a calendar overview of all tests and procedures for ongoing trials sponsored by the sponsor 142.

The project schedule calendar page 600 includes a calendar 602 that can be displayed according to different view options. As shown in FIG. 6, the calendar 602 is shown in the monthly view.

When an ongoing trial has a procedure scheduled for a particular day, the procedure is displayed as a calendar entry in the calendar 602. Selection of a particular calendar entry will result in an exploded view of the calendar entry, such as the exploded view 604 of an Oct. 15, 2009 calendar entry.

In some implementations, a stream selection link is shown if the procedure is ongoing when the calendar 602 is viewed. For example, assume that the date that the particular calendar entry being viewed as Oct. 15, 2009, and that the procedure listed in the exploded view 604 is ongoing. Because the procedure is ongoing, a live stream link 606 is shown in the exploded view 604. If the sponsor 142 selects the live stream link 606, a live video stream that shows the ongoing procedure is established. The live video stream may optionally have an audio link so that the sponsor 142 can discuss the procedure with the investigators performing the procedure.

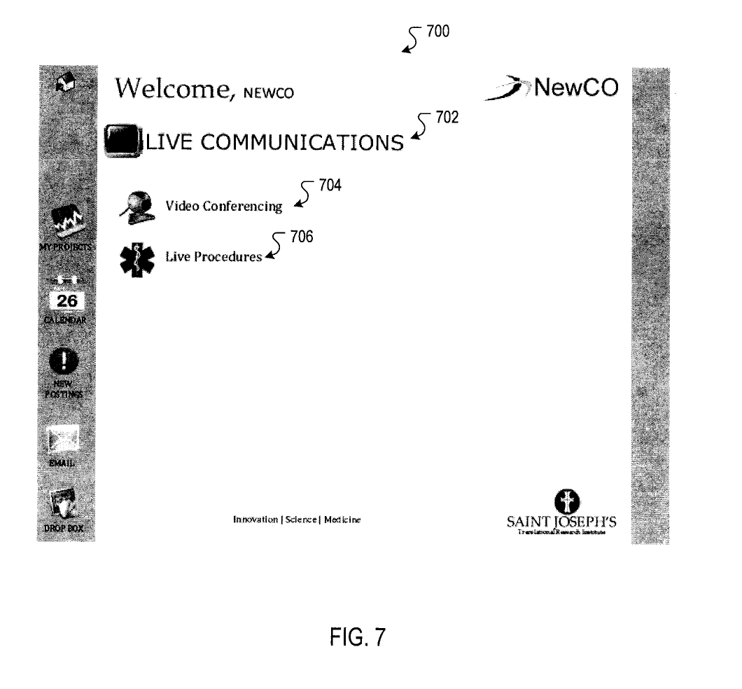

FIG. 7 is an image of a communications option page 700 for the trial data access and management system 100. The communications option page 700 is provided in response to a selection of the live communication icon 222 of FIG. 2.

The communications option page 700 includes a live communications heading 702, beneath which are live communication options, e.g., a video conferencing options 704 and a live procedures option 706. Other communication options can also be included if other communication options are supported by the system 100.

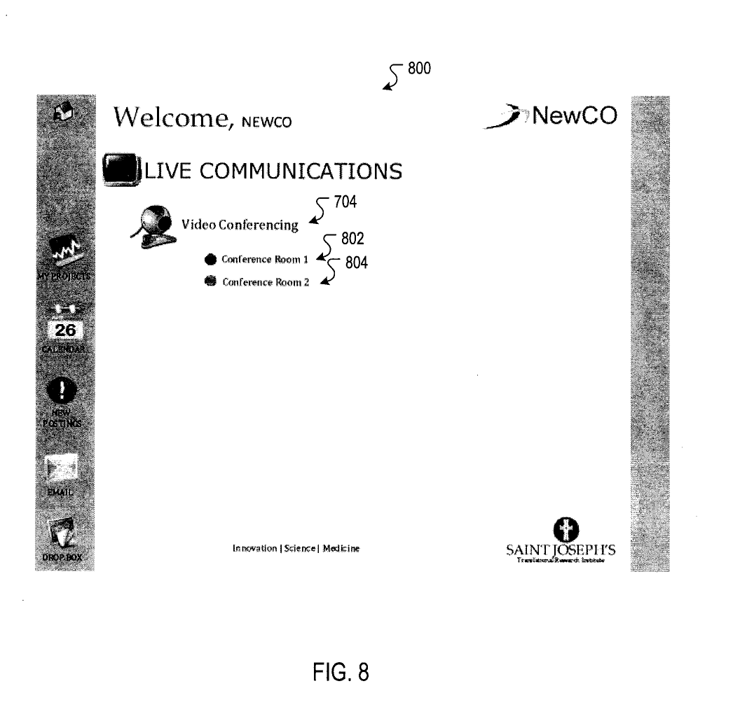

FIG. 8 is an image of a video conference selection page 800 for the trial data access and management system 100. The video conference selection page 800 is provided in response to the selection of the video conference option 704 of FIG. 7.

The video conference selection page 800 provides videoconferencing links 802 and 804 to videoconferencing enabled rooms at the test site. In some implementations, the videoconferencing links are color-coded to indicate whether there is an ongoing conference in which the sponsor 142 may participate. For example, the video conference link 804 is color-coded green, indicating there is a conference going on a conference room 2 that the sponsor 142 may join (e.g., by selecting the video conference link 804 to establish a video conference using the client device 140). The video conference link 802 is color-coded gray, indicating that the sponsor 142 cannot currently access the video conference link for conference room 1. The sponsor 142 may be denied access to conference room 1 because there is no conference ongoing in conference room 1, or because the conference ongoing in that conference room is for a trial that is being sponsored by a different sponsor.

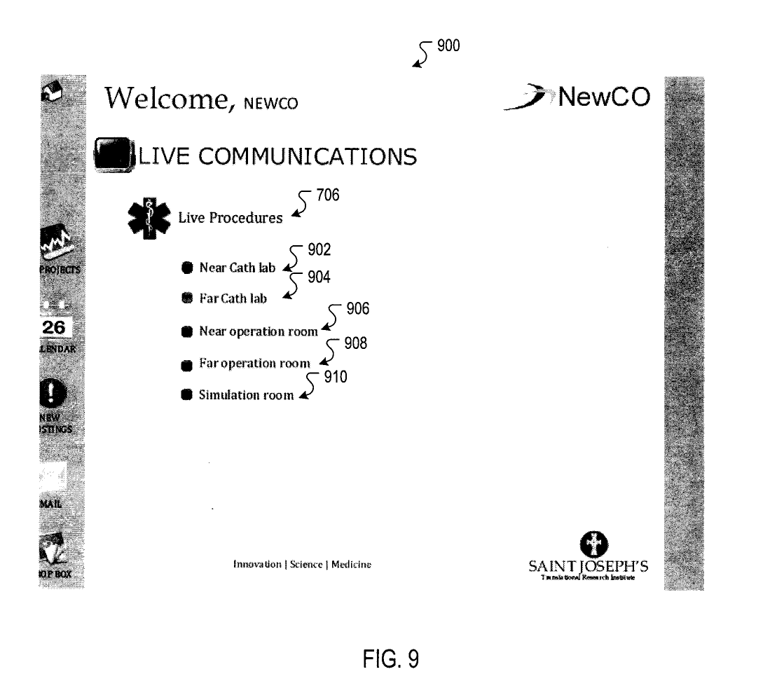

FIG. 9 is an image of a live procedure video feed selection page 900 for the trial data access and management system 100. The live procedure video feed selection page 900 is provided in response to a selection of the live procedures option 706 of FIG. 7.

The live procedure video feed selection page 900 provides videoconferencing links 902, 904, 906, 908 and 910. In some implementations, the videoconferencing links are color-coded to indicate whether there is an ongoing procedure that the sponsor 142 may view. For example, the video conference link 904 is color coded green, indicating there is an ongoing procedure in the catheter laboratory that the sponsor 142 may view (e.g., by selecting the link 904 to receive a video stream of the procedure). The live communications links 902, 906, 908 and 910 are color-coded gray, indicating that the sponsor 142 cannot currently receive a video stream from those respective laboratories and rooms. The sponsor 142 may be denied access because there are no ongoing procedures, or because the ongoing procedures are for trials that are being sponsored by different sponsors.

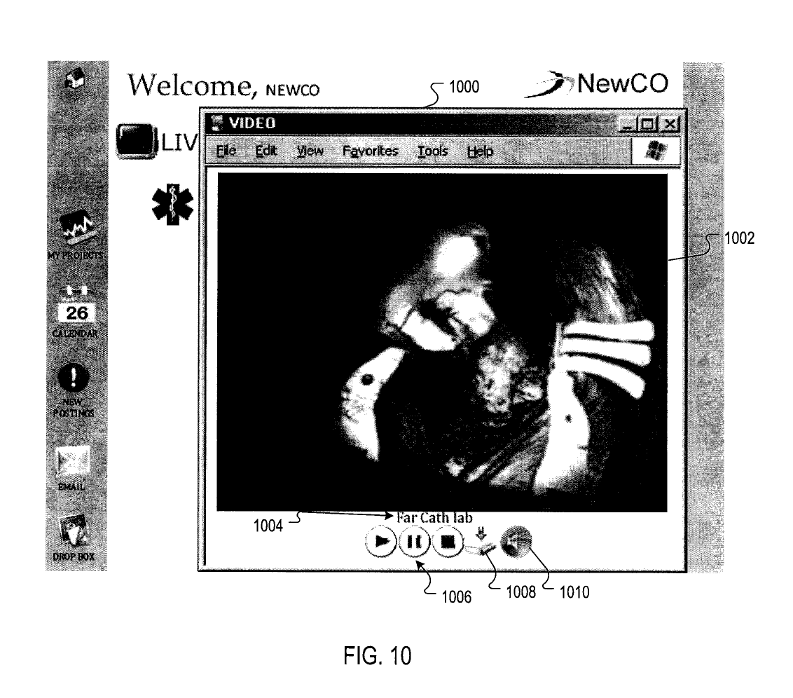

FIG. 10 is an image of a frame 1002 of a live procedure video feed 1000. The video feed 1000 is proved in response to the selection of the video conference link 904 of FIG. 9.

The video feed 1000 includes a location listing 1004 (e.g., “Far Cath Lab”), one or more playback controls 1006, a download control 1008, and an audio control 1010. The download control is used to store a local copy of the video received through the video feed 1000 on a client device 140. Selection of the audio control 1010 allows the sponsor 142 to receive audio with the video feed 1000. Additionally, if a two-way audio communication capability is available, then the sponsor 142 can communicate with the investigators while the procedure is ongoing.

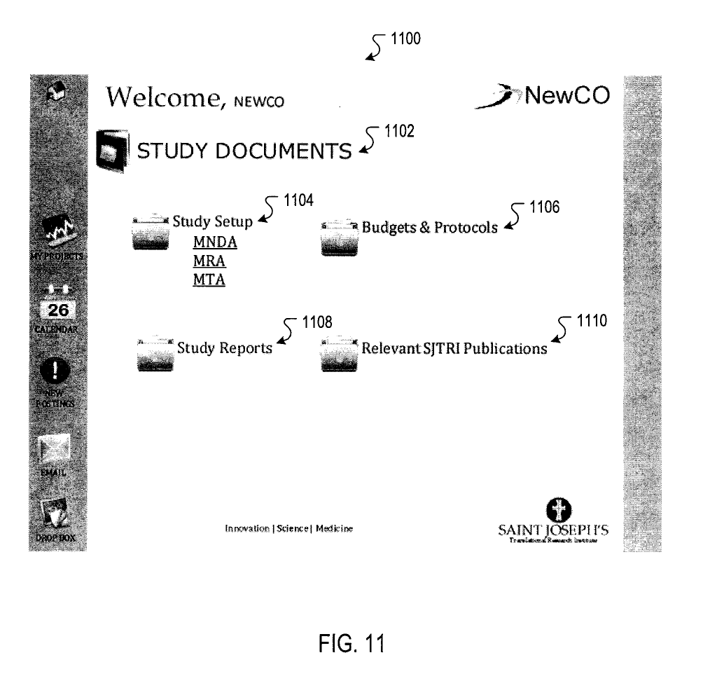

FIG. 11 is an image of a study documents page 1100 for the trial data access and management system 100. The study documents page 1100 is provided in response to a selection of the study documents icon 220 in the landing page 112.

The study documents page 1110 includes a study documents heading 1102, a study setup directory 1104, a budgets and protocols directory 1106, a study reports directory 1108, and a publications directory 1110.

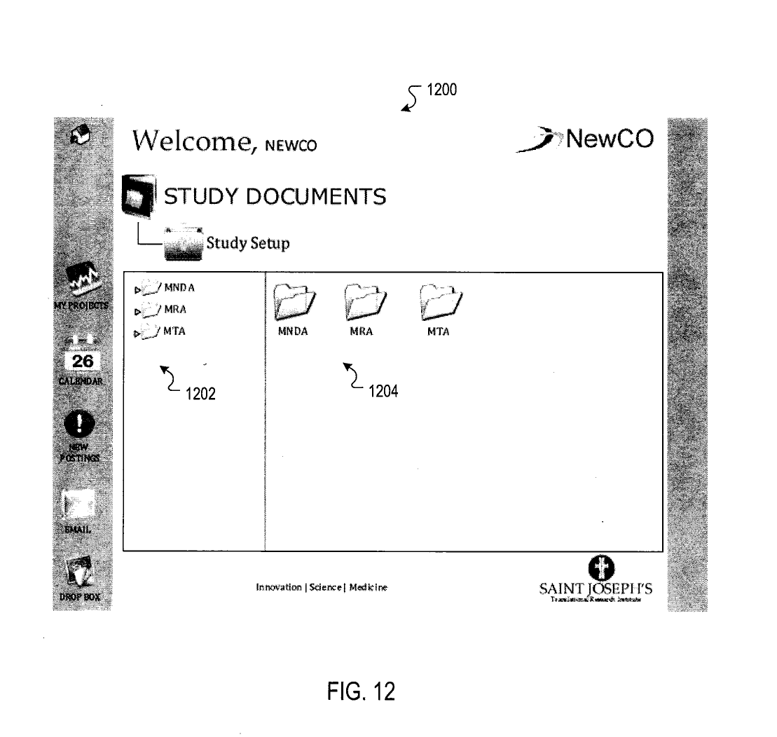

FIG. 12 is an image of a study setup page 1200 for the trial data access and management system 100. The study setup page 1200 is provided in response to a selection of the study setup directory 1104. The study setup page 1200 includes a directory tree 1202 that lists folders that are located in the study setup directory 1104, and a folder listing 1204 that lists the folders of an active (currently selected) directory. The three example folders shown in FIG. 12 relate to a Myeloid cell nuclear differentiation antigen (MNDA) trial, a Magnetic Resonance Angiography (MRA) trial, and a Molecular Targeted Agents (MTA) trial. A sponsor 142, by selecting any corresponding folder, can access documents pertaining to the study setup.

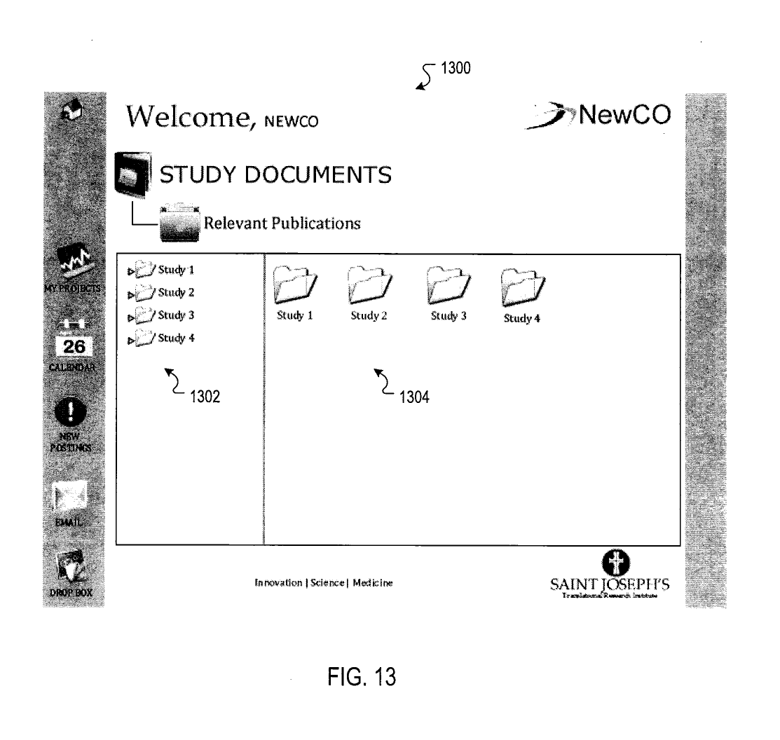

FIG. 13 is an image of a publications page 1300 for the trial data access and management system 100. The publications page 1300 is provided in response to a selection of the publications directory 1110. The publications page 1300 includes a directory tree 1302 that lists folders that are located in the publications directory 1104, and a folder listing 1304 that lists the folders of an active (currently selected) directory. A sponsor 142, by selecting any corresponding folder, can access publications related to a particular study.

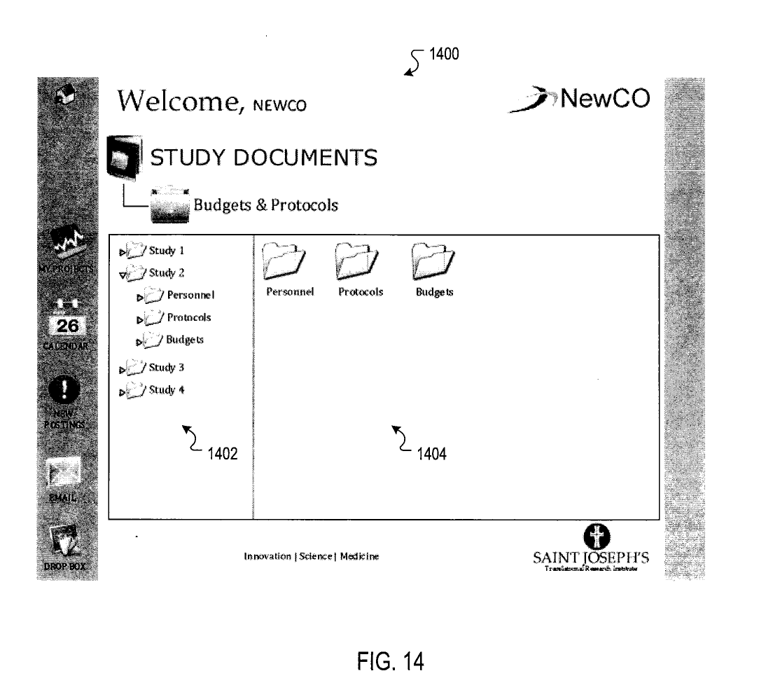

FIG. 14 is an image of a budgets and protocols page 1400 for the trial data access and management system 100. The budgets and protocols page 1400 is provided in response to a selection of the budgets and protocol directory 1106. The budgets and protocol page 1400 includes a directory tree 1402 that lists folders that are located in the budgets and protocols directory 1106, and a folder listing 1404 that lists folders that are located in the active directory, e.g., the directory “Personnel” in the directory “Study 2.” The example folders in the folder listing 1404 includes documents related to personnel carrying out the trial (investigators), protocols that govern the trial, and budgets for the trial, respectively.

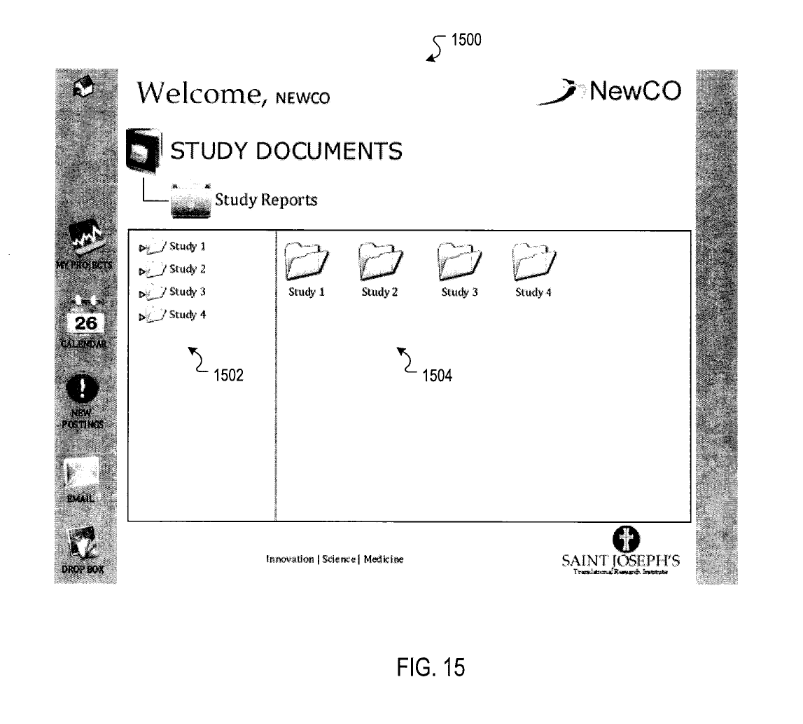

FIG. 15 is an image of a study reports page 1500 for the trial data access and management system 100. The study reports page 1500 is provided in response to a selection of the study reports directory 1108. The study reports page 1500 includes a directory tree 1502 that lists folders that are located in the study reports directory 1108, and a folder listing 1504 that lists folders that are located in the active directory. The example folders in the folder listing 1504 include documents related to reports for ongoing trials Study 1, Study 2, Study 3 and Study 4, respectively. The reports can, for example, be reports that are generated by the investigators and/or the sponsor 142.

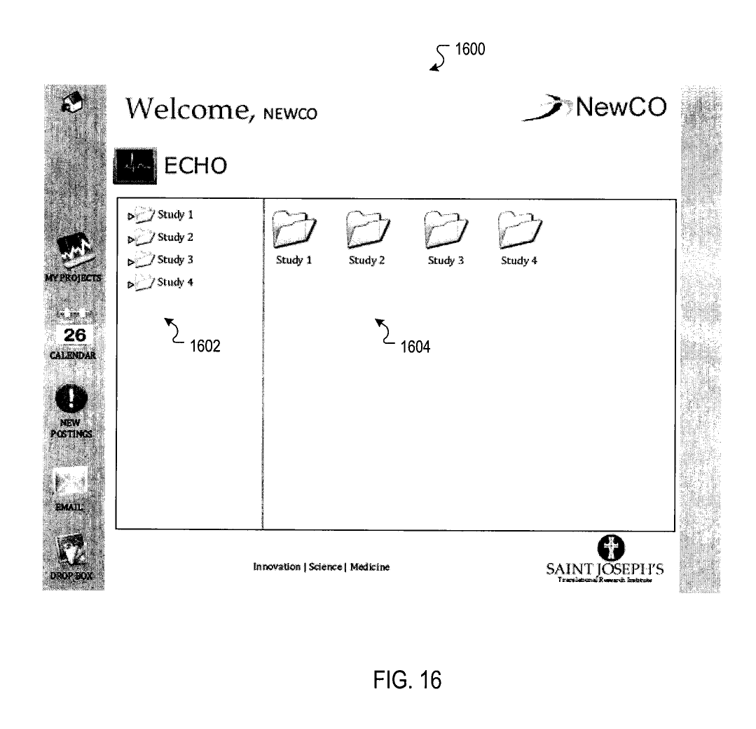

FIG. 16 is an image of an echocardiogram page 1600 for the trial data access and management system 100. The echocardiogram page 1600 is provided in response to selection of the echocardiogram icon 226 on the landing page 112. The echocardiogram page 1600 includes a directory tree 1604 that lists folders for each ongoing trial, i.e. Study 1, Study 2, Study 3 and Study 4. A folder listing 1604 includes a list of each folder that can be selected from an active directory.

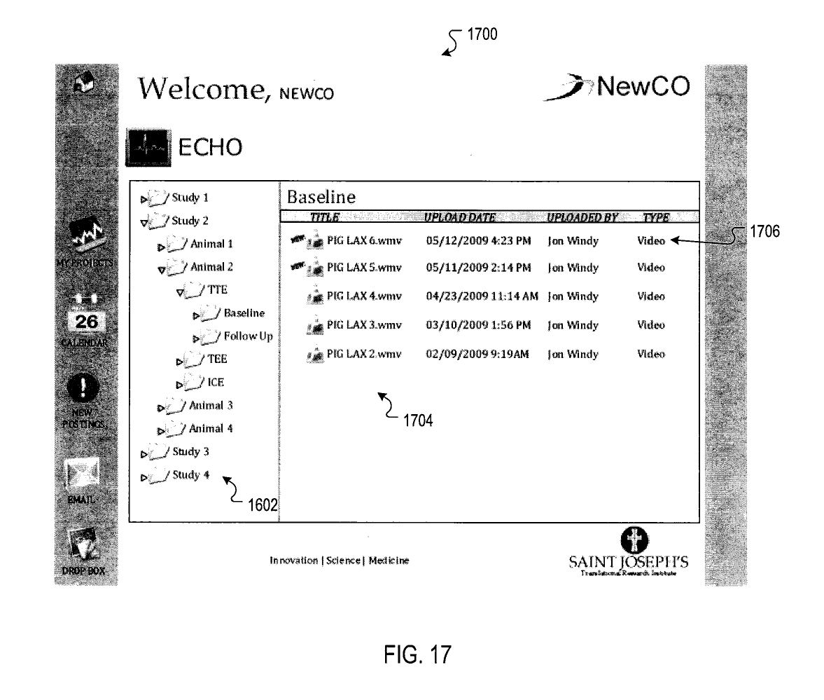

Each of the folders in the folder listing 1604 includes echocardiogram data for an ongoing trial. The data can include records, reports, images, and videos. Examples of videos are shown in FIG. 17, which is an image of an echocardiogram files page 1700 for the trial data access and management system 100. The echocardiogram files page 1700 is provided in response to a selection of the baseline folder listed in the directory tree 1604. The echocardiogram files page 1700 includes a video files listing 1704 of echocardiogram videos. The video files are not live video streams; instead, the video files are archives of video streams and other videos that may be generated for the ongoing trial. If a video file has not been selected by the sponsor 142, then the video file is marked as a new video file, such as the video file 1706 that is list of the top of the video files listing 1704.

Although only video files are shown, other files can also be included in the folder “Baseline.” For example, reports, images, and other data files can be stored in the folders listed in the directory listing 1604.

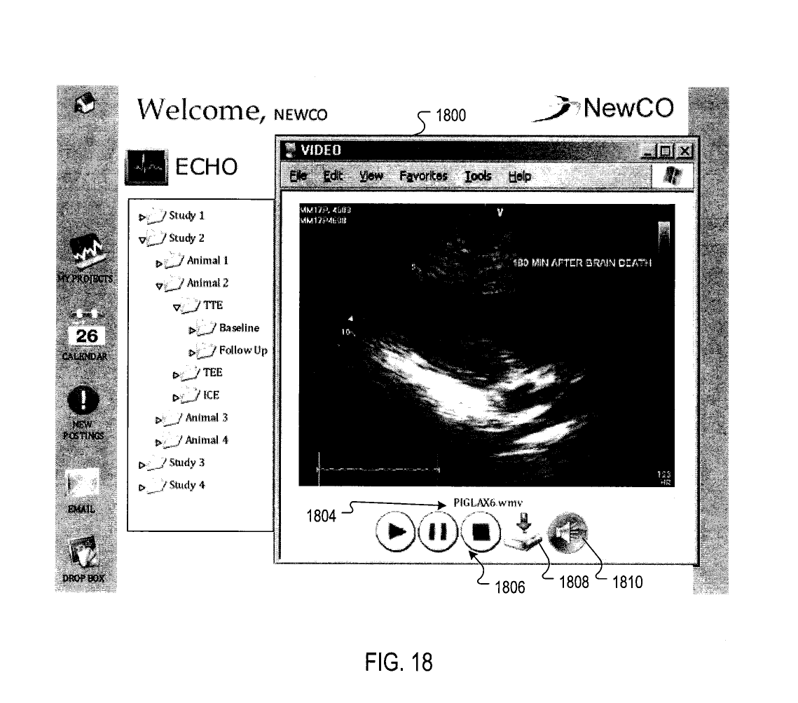

FIG. 18 is an image of a frame 1802 of an echocardiogram video 1800. The echocardiogram video 1800 is provided in response to a selection of one of the echocardiogram videos listed in the video files listing 1704. For example, the echocardiogram video 1800 is generated in response to a selection of the video file 1706 in FIG. 17. The echocardiogram video 1800 includes a title 1804, one or more controls 1806, a download control 1808, and an audio control 1810. The download control 1808 is used to store a local copy of the video on a client device 140. Selection of the audio control 1810 adjusts the audio volume of the video. The audio accompanying the video may be a recording of the investigators comments, or, if the sponsor 142 was communicating with the investigators while the procedure was ongoing, a recording of the conversation between the sponsor 142 and the investigators.

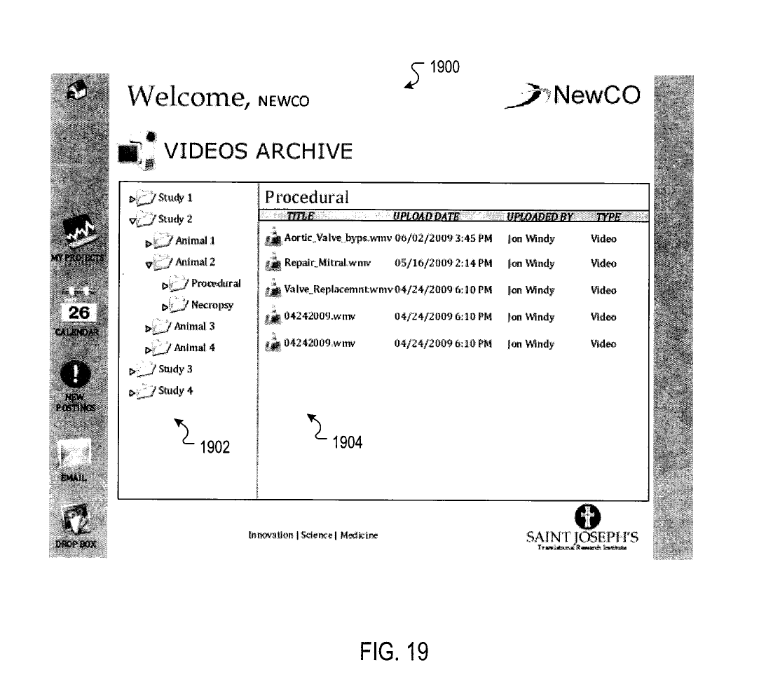

FIG. 19 is an image of a video archives page 1900 for the trial data access and management system 100. The video archives page 1900 is provided in response to selection of the video archive icon 224 in the landing page 112. The video archives page 1900 includes a directory listing 1902 that lists folders for each ongoing trial, and subfolders within each ongoing trial that correspond to a participant participating in the, e.g., Animal 1, Animal 2, Animal 3, and Animal 4 for the ongoing trial “Study 2.” In some implementations, all videos for all procedures and test are stored within the folder for each participant. In other implementations, the videos may be categorized according to two or more categories. For example, in FIG. 19, the videos for the participant Animal 2 categorized according to “Procedural” and “Necropsy” categories.

The video archives page 1900 includes a video files listing 1904 that lists video files in a currently selected folder. For example, as shown in FIG. 19, the video files listing 1904 lists all files stored in the folder “Procedural” within the folder “Animal 2.” Selection of any one of the video files results in a video file being played back on the sponsor client device in an environment similar to the environment described in FIG. 18.

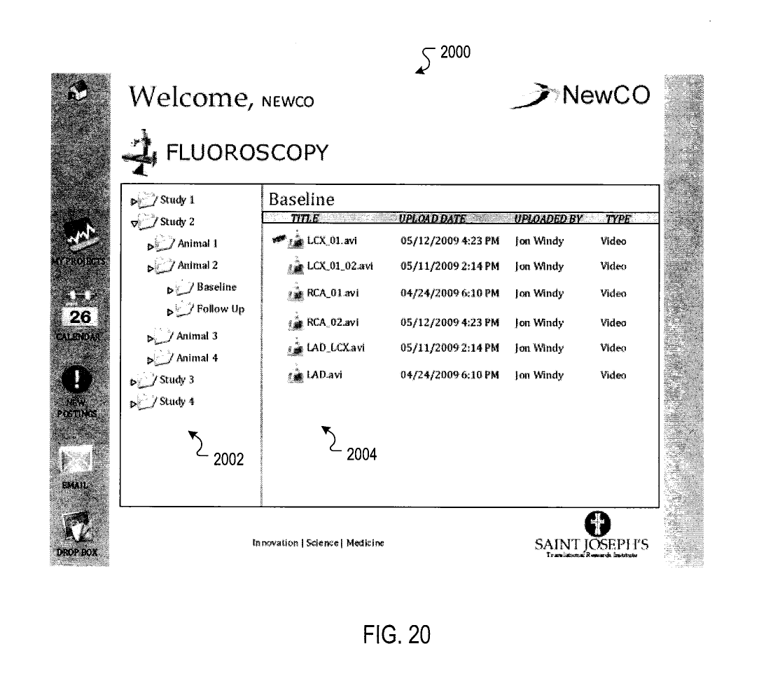

FIG. 20 is an image of a fluoroscopy page 2000 for the trial data access and management system 100. The fluoroscopy page 2000 is provided in response to selection of the fluoroscopy icon 230 in the landing page 112. The fluoroscopy page 2000 includes a directory listing 2002 that lists folders for each ongoing trial, and subfolders within each ongoing trial that correspond to a participant participating in the, e.g., Animal 1, Animal 2, Animal 3, and Animal 4 for the ongoing trial “Study 2.” In some implementations, fluoroscopy videos are categorized according to a baseline category and a follow up category.

The fluoroscopy page 2000 includes a video files listing 2004 that lists video files in a currently selected folder. For example, as shown in FIG. 12, the video files listing 2004 list all files stored in the folder “Baseline” within the folder “Animal 2.” Selection of any one of the video files results in a video file being played back on the sponsor environment in an environment similar to the environment described in FIG. 18.

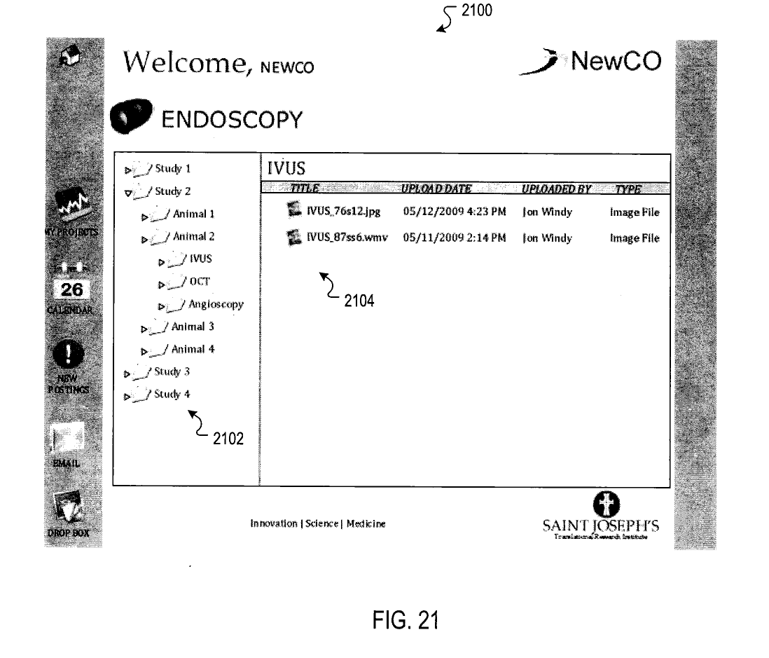

FIG. 21 is an image of an endoscopy page 2100 for the trial data access and management system 100. The endoscopy page 2100 is provided in response to selection of an endoscopy icon 232 in the landing page 112. The endoscopy page 2100 includes a directory listing 2102 that lists folders for each ongoing trial, and subfolders within each ongoing trial that correspond to a participant participating in the trial. In some implementations, endoscopy videos are categorized according to two or more categories.

The endoscopy page 2100 includes a video files listing 2104 that lists video files in a currently selected folder. For example, as shown in FIG. 21, the video files listing 2104 list all files stored in the folder “IVUS” within the folder “Animal 2.” Selection of any one of the video files results in a video file being played back on the sponsor client device in an environment similar to the environment described in FIG. 18.

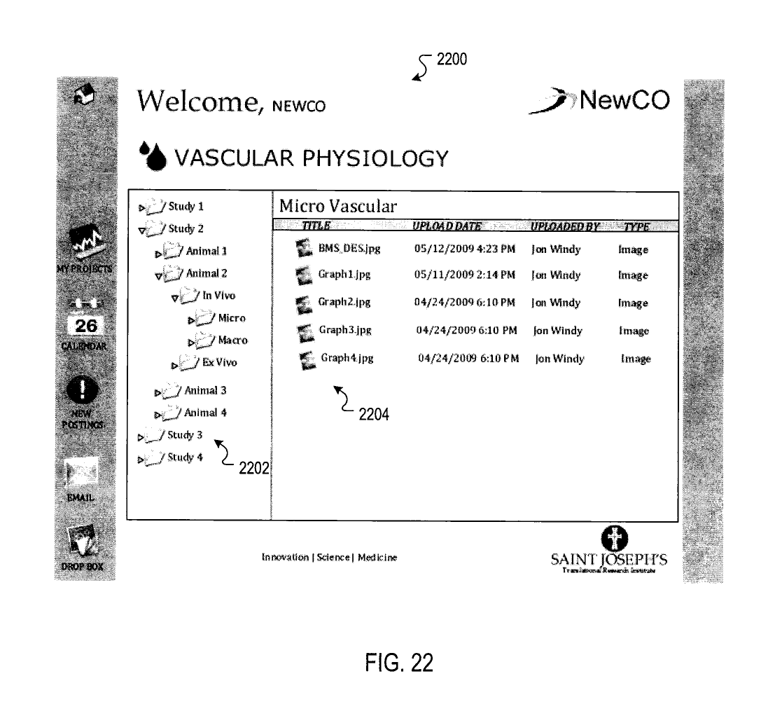

FIG. 22 is an image of a vascular physiology page 2200 for the trial data access and management system 100. The vascular physiology page 2200 is provided in response to selection of the vascular physiology icon 234 in the landing page 112. The vascular physiology page 2200 includes a directory listing 2202 that lists folders for each ongoing trial, and subfolders within each ongoing trial that correspond to a participant participating in the trial. In some implementations, vascular physiology images are categorized according to two or more categories.

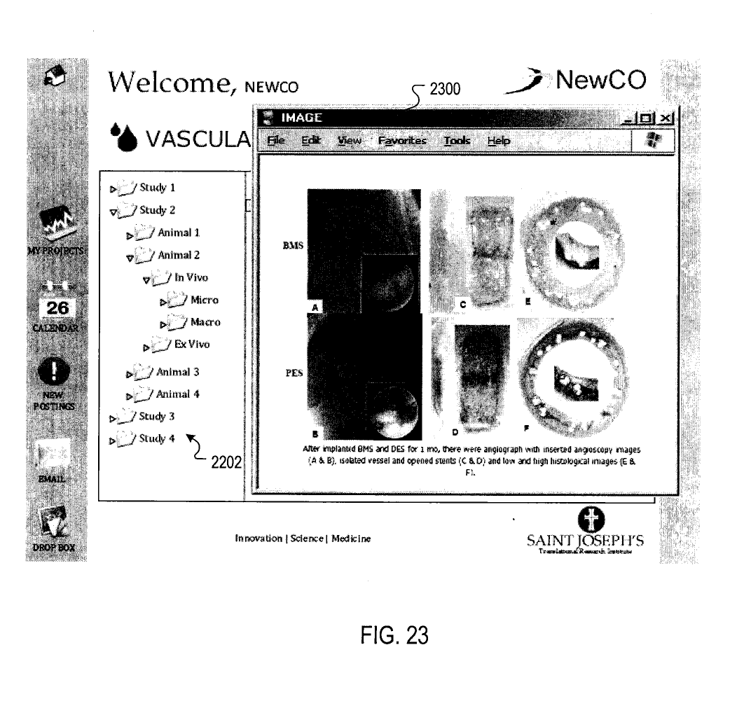

The vascular physiology page 2200 includes an image listing 2104 that lists image files in a currently selected folder. For example, as shown in FIG. 22, the image files listing 2204 list all images stored in the folder “Micro Vascular” within the folder “In Vivo.” Selection of any one of the image files results in a display of the image. For example, in FIG. 23, a vascular physiology report image 2300 is displayed in the vascular physiology page 2200 in response to a selection of the file entitled “Bes_Des.jpg.”

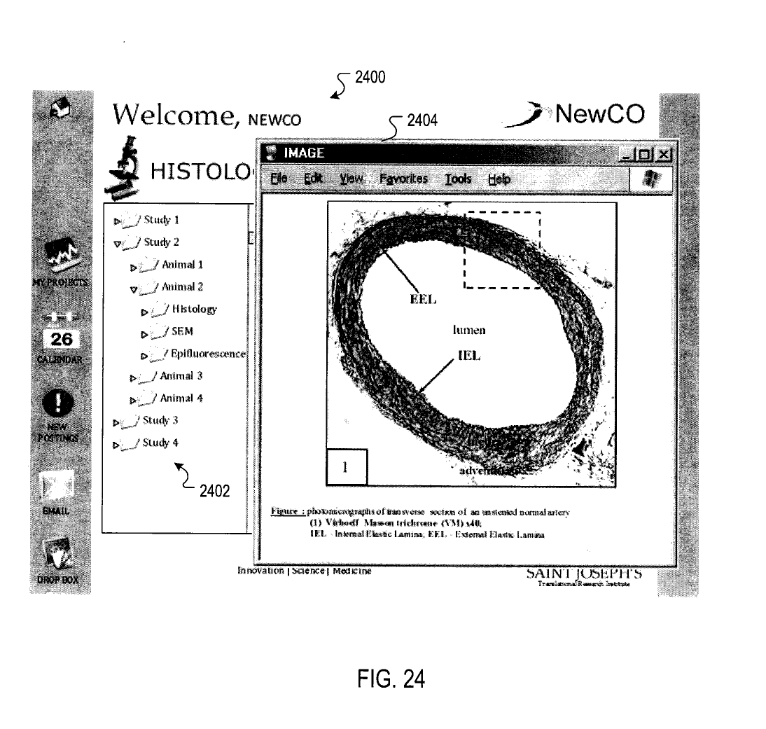

FIG. 24 is a histological report image 2404 displayed in histology page 2400. The histology page 2400 is provided in response to selection of the histology icon 236 in the landing page 112. The histology report image 2400 is displayed in response to a selection of an image from an image list that list image files stored in a currently selected folder, e.g., a currently selected folder from one of the folders in the directory listing 2402 that lists folders for each ongoing trial.

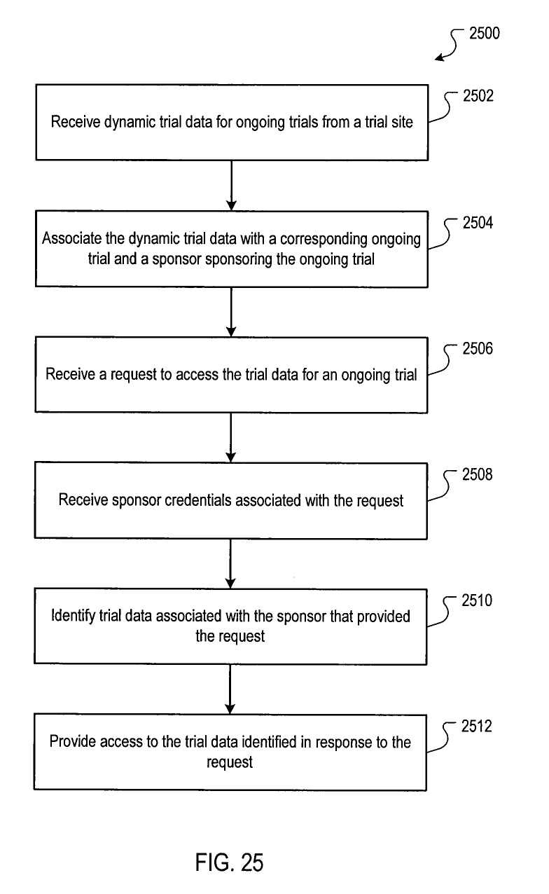

FIG. 25 is a flow chart of an example process 2500 for managing dynamic data for a trial. The process 2500 can be implemented in the data processing apparatus 110.

The process 2500 receives dynamic trial data for ongoing trials from a trial site (2502). Each of the ongoing trials are sponsored by a respective sponsor and are being conducted according to a respective protocol specifying subjects participating in the ongoing trial and a schedule of procedures and tests for the ongoing trial. The dynamic trial data for each ongoing trial are data describing current states of subjects participating in the ongoing trial and data collected in response to actions taken according to the schedule of procedures and tests specified by the protocol for the ongoing trial.

The process 2500 associates the dynamic trial data with a corresponding ongoing trial and a sponsor sponsoring the ongoing trial (2504). For example, the dynamic trial data may be tagged with a sponsor identifier and trial identifier, and the data processing apparatus 110 can use this tag to associate the dynamic trial data with a sponsor and a trial that is being sponsored by the sponsor.

The process 2500 receives a request to access the trial data for an ongoing trial (2506). For example, the data processing apparatus 110 can receives a login request from a client device.

The process 2500 receives sponsor credentials associated with the request (2508). The sponsor credentials identify a sponsor that provided the request. For example, the data processing apparatus 110 can receive a login identifier and a password.

The process 2500 identifies trial data associated with the sponsor that provided the request. For example, the data processing apparatus 110 can validate the sponsor credentials and identify the trials being sponsored by the identified sponsor.

The process 2500 provides access to the trial data identified in response to the request (2510). The access to the trial data including access to the dynamic trial data for the ongoing trial. For example, the data processing apparatus 110 can provide a landing page 112 through which the trial data for trials being sponsored by the sponsor can be accessed.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

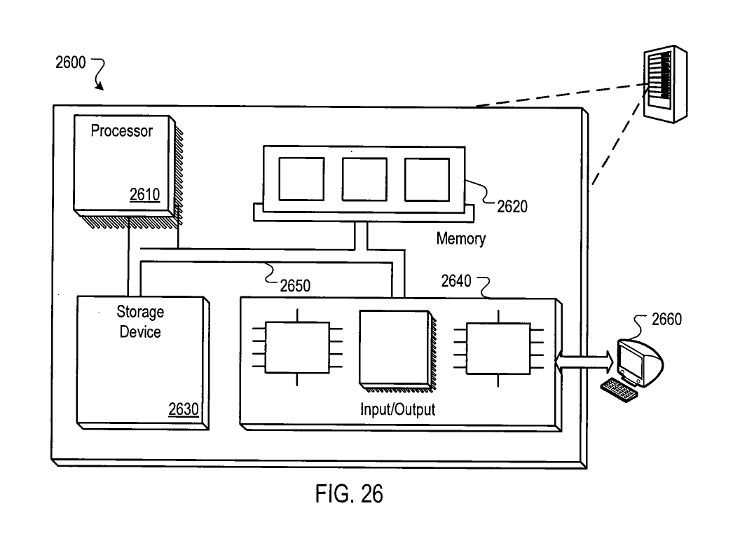

An example of a computer in which the above-described techniques can be implemented is shown in FIG. 26, which shows a block diagram of a programmable processing system (system). The system 2600 can be utilized to implement the systems and methods described herein. The architecture of the system 2600 can, for example, be used to implement a computer client, a computer server, or some other computer device.

The system 2600 includes a processor 2610, a memory 2620, a storage device 2630, and an input/output device 2640. Each of the components 2610, 2620, 2630, and 2640 can, for example, be interconnected using a system bus 2650. The processor 2610 is capable of processing instructions for execution within the system 2600. In one implementation, the processor 2610 is a single-threaded processor. In another implementation, the processor 2610 is a multi-threaded processor. The processor 2610 is capable of processing instructions stored in the memory 2620 or on the storage device 2630.

The memory 2620 stores information within the system 2600. In one implementation, the memory 2620 is a computer-readable medium. In one implementation, the memory 2620 is a volatile memory unit. In another implementation, the memory 2620 is a non-volatile memory unit.

The storage device 2630 is capable of providing mass storage for the system 2600. In one implementation, the storage device 2630 is a computer-readable medium. In various different implementations, the storage device 2630 can, for example, include a hard disk device, an optical disk device, or some other large capacity storage device.

The input/output device 2640 provides input/output operations for the system 2600. In one implementation, the input/output device 2640 can include one or more of a network interface devices, e.g., an Ethernet card, a serial communication device, e.g., and RS-232 port, and/or a wireless interface device, e.g., an 802.11 card. In another implementation, the input/output device can include driver devices configured to receive input data and send output data to other input/output devices, e.g., keyboard, printer and display devices 2660.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A system, comprising:
a data store storing trial data for ongoing trials, each ongoing trial sponsored by a respective sponsor and being conducted according to a respective protocol specifying subjects participating in the ongoing trial and a schedule of procedures and tests for the ongoing trial, and wherein the trial data include dynamic trial data for each ongoing trial, the dynamic trial data for each ongoing trial being data describing current states of subjects participating in the ongoing trial and data collected in response to actions taken according to the schedule of procedures and tests specified by the protocol for the ongoing trial;
a data processing apparatus in data communication with the data store, the data processing apparatus including a memory storing instructions executable by the data processing apparatus and that upon such execution cause the data processing apparatus to perform operations comprising:
receive, over a network, dynamic trial data for an ongoing trial from a trial site;
associate the dynamic trial data with a corresponding ongoing trial and sponsor sponsoring the ongoing trial;
store the dynamic trial data for the ongoing trial in the data store;
receive, over the network, a request to access the trial data for an ongoing trial;
receive, from a client device, sponsor credentials associated with the request, the sponsor credentials identifying a sponsor that provided the request;
identify trial data associated with the sponsor that provided the request; and
provide access to the trial data identified in response to the request, the access to the trial data including access to the dynamic trial data for the ongoing trial.

2. The system of claim 1, wherein the dynamic trial data includes trial records, each trial record detailing biological parameters and procedures related to one or more subjects participating in the ongoing trial.

3. The system of claim 2, wherein the dynamic trial data includes an assessment result record including one or more images.

4. The system of claim 2, wherein the dynamic trial data includes trial video resources, each trial video resource being a video of a procedure performed on a subject participating in the ongoing trial.

5. The system of claim 4, wherein the instructions cause the data processing apparatus to perform the operations of:
receive live video streams, each live video stream being a video stream of an ongoing procedure being performed on a subject participating in an ongoing trial at the trial site;
provide the live video stream to the client device; and
store the live video stream in the dynamic trial data for the ongoing trial.

6. The system of claim 5, wherein the trial video resources include archived video files, each archived video file being a recording of an procedure that was performed a subject participating in an ongoing trial.

7. The system of claim 5, wherein each of the ongoing trials are preclinical trials.

8. The system of claim 7, wherein the trial site at which each of the ongoing trials are being conducted is a vivarium, and the system further comprises:
a plurality of computer devices located within the vivarium and in data communication with the data processing apparatus, the computer devices receiving dynamic trial data input by one or more investigators carrying out an ongoing trial according to the respective protocol for the ongoing trial; and
wherein the instructions cause the data processing apparatus to perform the operation of receiving the dynamic trial data from the plurality of computer devices.

9. The system of claim 8, wherein the data processing apparatus and the data store are remotely located from the trial site.

10. The system of claim 5, wherein dynamic trial data for each ongoing trial are grouped according procedures being performed for the ongoing trial.

11. The system of claim 5, wherein dynamic trial data for each ongoing trial are grouped according to two or more of echocardiogram data, magnetic resonance imaging data, fluoroscopy data, endoscopy data, histological data, and vascular physiology data.

12. The system of claim 2, wherein the biological parameters include blood pressure, respiratory rate, and oxygen levels.

13. The system of claim 1, further comprising:
a client device in data communication with the data processing apparatus, the client device including a memory and a processor, the memory storing instructions executable by the processor and that upon such execution cause the client device to perform operations comprising:
provide, over the network, the request to access the trial data for an ongoing trial and the sponsor credentials associated with the request; and
access the trial data, including the dynamic trial data, for the ongoing trial.

14. A method implemented on a data processing apparatus, the method comprising:
receiving, over a network, dynamic trial data for ongoing trials from a trial site, each ongoing trial sponsored by a respective sponsor and being conducted according to a respective protocol specifying subjects participating in the ongoing trial and a schedule of procedures and tests for the ongoing trial, the dynamic trial data for each ongoing trial being data describing current states of subjects participating in the ongoing trial and data collected in response to actions taken according to the schedule of procedures and tests specified by the protocol for the ongoing trial;
associating the dynamic trial data with a corresponding ongoing trial and sponsor sponsoring the ongoing trial;
storing the dynamic trial data for the ongoing trial in the data store;
receiving, over the network, a request to access the trial data for an ongoing trial;
receiving, from a client device, sponsor credentials associated with the request, the sponsor credentials identifying a sponsor that provided the request;
identifying trial data associated with the sponsor that provided the request; and
providing access to the trial data identified in response to the request, the access to the trial data including access to the dynamic trial data for the ongoing trial.

15. The method of claim 14, wherein the dynamic trial data includes trial records, each trial record detailing biological parameters and procedures related to one or more subjects participating in the ongoing trial.

16. The method of claim 15, wherein the dynamic trial data includes an assessment result record including one or more images.

17. The method of claim 15, wherein the dynamic trial data includes trial video resources, each trial video resource being a video of a procedure performed on a subject participating in the ongoing trial.

18. The method of claim 17, further comprising:
receiving live video streams, each live video stream being a video stream of an ongoing procedure being performed on a subject participating in an ongoing trial at the trial site;
providing the live video stream to the client device; and
storing the live video stream in the dynamic trial data for the ongoing trial.

19. The method of claim 17, wherein each of the ongoing trials are preclinical trials.
